(19) United States
(12) Patent Application Publication
(10) Pub. No.: US 2005/0182867 A1
(43) Pub. Date: Aug. 18, 2005

(54) Systems and methods for signaling write status

(76) Inventor: Eddy Reynolds, Tomball, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/781,524

(22) Filed: Feb. 17, 2004

(51) Int. Cl. G06F 3/00

(52) U.S. Cl. 710/33

(57) ABSTRACT

In one embodiment, a system and a method for signaling write status pertain to detecting transfer of data to an external storage device plugged into an input/output port associated with a computer, and activating a write-in-progress indicator that signals that writing has not been completed by the external storage device.

### BACKGROUND

Computers, such as personal computers (PCs), typically comprise multiple input/output (I/O) ports with which the computer can connect, and therefore communicate, with other devices. Today, such ports are provided on the back panel of the computer for semi-permanent connections, as well as the front panel of the computer to facilitate “hot plugging” in which a device may be connected to the computer for a short period of time, e.g., just long enough to upload data to or download data from the computer.

More and more often, universal serial bus (USB) connectors are provided on consumer devices to facilitate connection to a computer. Such consumer devices include external storage devices such as external hard drives, zip drives, and so-called memory “keys” that contain solid-state memory and which are small enough to carry on a key chain.

Some external storage devices that are intended for hot plugging comprise internal buffers in which data received from a computer is cached pending writing of the data to the storage medium contained in the device (e.g., disk, nonvolatile solid-state memory). Such buffers permit data to be transferred from the computer to the device more quickly to increase the perceived speed of downloading of data to the external storage device.

When a user downloads data to an external storage device, the computer operating system may display a pop-up message indicating that the data has been written to the device. Although it may be true that the data has been transferred to the device at that point, additional time may still be required for that transferred data to be written to the storage media. Accordingly, it is possible for the user to, even after viewing the message indicating that writing has been complete, withdraw the external storage device plug from the computer port before such writing is actually completed. In such a case, data may be lost and the download procedure may need to be repeated to ensure that all data has indeed been written to the device.

### SUMMARY OF THE DISCLOSURE

In one embodiment, a system and a method for signaling write status pertain to detecting transfer of data to an external storage device plugged into an input/output port associated with a computer, and activating a write-in-progress indicator that signals that writing has not been completed by the external storage device.

### BRIEF DESCRIPTION OF THE DRAWINGS

The disclosed systems and methods can be better understood with reference to the following drawings. The components in the drawings are not necessarily to scale.

FIG. 1 is a perspective view of an embodiment of a computer and a connector hub, both of which being configured to signal a user as to when writing to an external storage device has been completed.

FIG. 2 is a partial view of the computer shown in FIG. 1.

FIG. 3 is a perspective view of a connector hub shown in FIG. 1.

FIG. 4 is a block diagram of embodiments of the configurations of the computer and connector hub shown in FIG. 1.

FIG. 5 is a block diagram of an embodiment of a configuration of an external storage device shown in FIG. 1.

FIG. 6 is a flow diagram that illustrates an embodiment of a method for signaling write completion.

FIG. 7 is a flow diagram that illustrates an embodiment of operation of a write monitor shown in FIG. 4.

FIG. 8 is a flow diagram that illustrates an embodiment of operation of an external storage medium in communicating a write completion status.

FIG. 9 is a flow diagram that illustrates a further embodiment of a method for signaling write completion.

### DETAILED DESCRIPTION

Disclosed herein are embodiments of systems and methods for signaling the write status of an external storage device. In some embodiments, a computer monitors the progress of an external storage device in writing data obtained from an internal buffer to storage media contained within the device. When the computer detects or determines that completion, the computer signals the user as to such completion. By way of example, writing completion is signaled with an indicator, such as an indicator light, positioned adjacent a port to which the external storage device is connected.

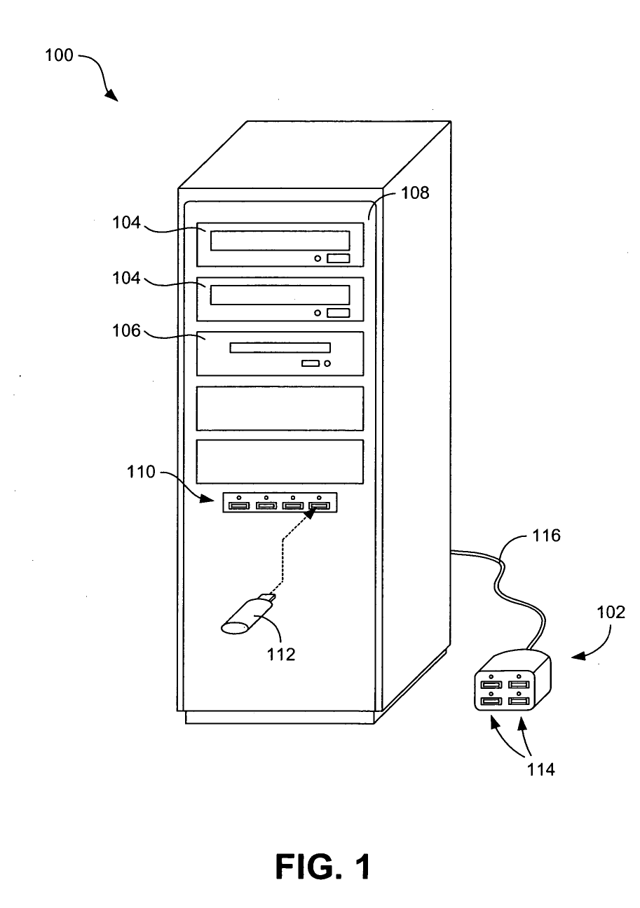

Referring now to the drawings, in which like numerals indicate corresponding parts throughout the several views, FIG. 1 illustrates a computer 100 and a connector hub 102 that is connected to the computer. As shown in FIG. 1, the computer 100 includes storage medium drives including, in this example, two CD drives 104 and one floppy disk drive 106. Each of those drives is mounted in a front panel 108 of the computer 100 so as to be easily accessible to the user. Further mounted in the front panel 108 are input/output (I/O) ports 110 that are also easily accessible to the user so as to facilitate hot plugging of external devices into the computer 100. By way of example, the I/O ports 10 comprise universal serial bus (USB) ports. Although USB ports have been explicitly identified, the I/O ports 110 could include other types of ports including IEEE 1394 (“firewire”) ports. Indeed, the I/O ports 110 can comprise any type of port to which an external storage device containing an internal buffer can connect.

Further illustrated in FIG. 1 is an external storage device 112 that is configured for receipt by the I/O ports 110. Although, in this example, the storage device 112 comprises a memory key that includes nonvolatile, solid-state storage media and a USB connector, the device is generally representative of an external storage device that can connect to the computer 100 via an I/O port 110. Therefore, the present disclosure is equally relevant to other external storage devices including, for example, external hard drives, zip drives, and the like.

The connector hub 102 also includes I/O ports 114, which can be of similar or different configurations relative to the I/O ports 110 of the computer 100. By way of example, the I/O ports 114 comprise USB and/or IEEE ports. The connector hub 102 connects to the computer 100 via a communication cable 116, which may comprise a USB and/or IEEE cable. With such a configuration, the connector hub 102 can be used to plug into a single port of the computer 100 (e.g., on the back panel) and receive the plugs of several other devices (e.g., digital cameras, external storage devices, joysticks, etc.) so as to expand the effective number of ports of the computer.

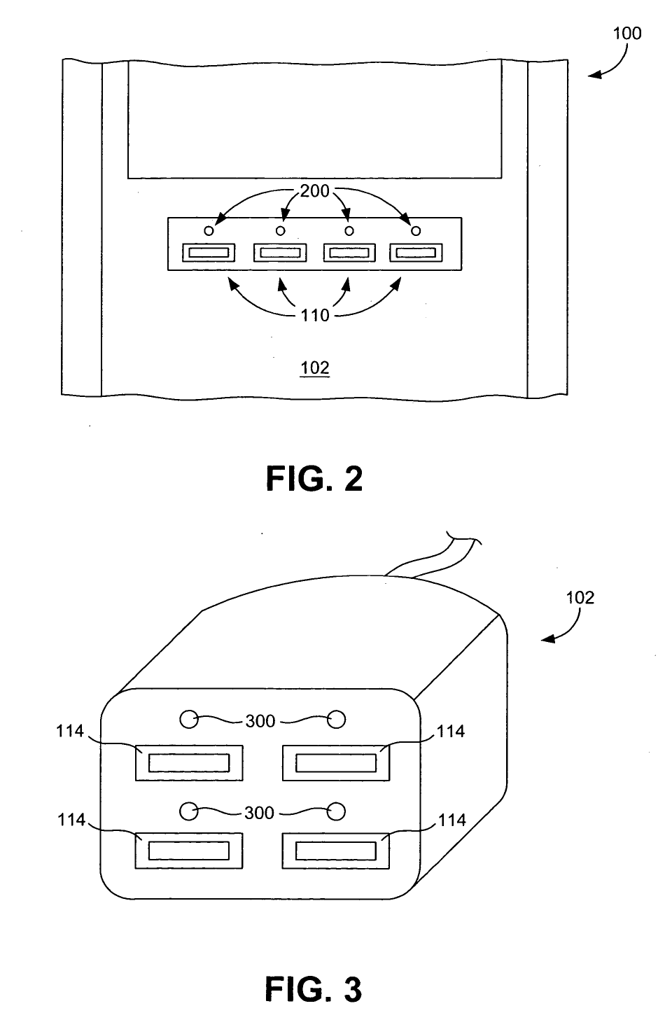

FIG. 2 illustrates a portion of the computer 100 of FIG. 1 in greater detail. As shown in FIG. 2, four I/O ports 110 are provided in the example computer 100 (in its front panel 108) and each of these ports comprises its own indicator 200. By way of example, the indicators 200 comprise indicator lights, such as light-emitting diode (LED) indicators. Each indicator 200 is positioned adjacent its associated I/O port 110 such that the user can readily determine which indicator provides information as to which port.

FIG. 3 illustrates the connector hub 102 of FIG. 1 in greater detail. As shown in FIG. 3, the example connector hub 102 also includes four I/O ports 114, each of which includes its own indicator 300. Again, the indicators 300 can comprise indicator lights, such as LED indicators, and are positioned adjacent their associated I/O ports 114 so it is clear to which port each indicator pertains.

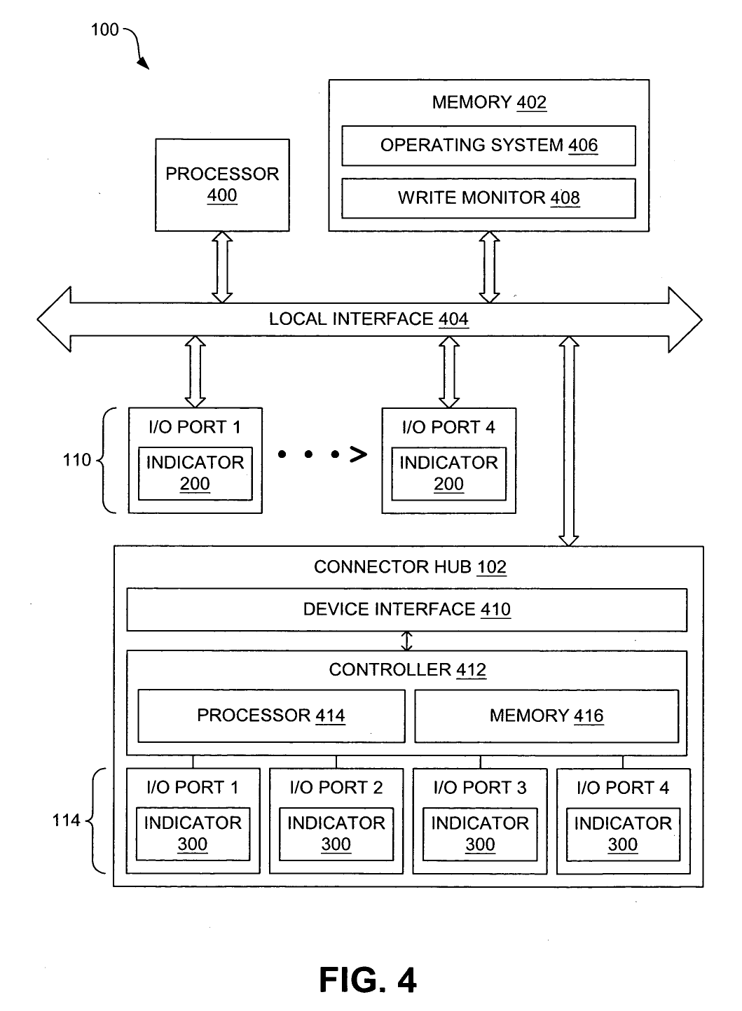

FIG. 4 illustrates an example configuration for the computer 100 and connector hub 102 of FIG. 1. As indicated in FIG. 4, the computer 100 comprises a processor 400 and memory 402, each of which is connected to a local interface 404. Also connected to the local interface 404 are the I/O ports 110 (four such ports in the example embodiment) and their associated indicators 200. Although the indicators are illustrated as comprising part of the I/O ports 110, the indicators could be separate and independent of the ports. As is further shown in FIG. 1, the connector hub 102 is also connected to the computer local interface 404. As described above, that connection may be facilitated by a communication cable (e.g., cable 116 in FIG. 1).

The computer processor 400 can include a central processing unit (CPU) or an auxiliary processor among several processors associated with the computer 100. The memory 402 includes any one of or a combination of volatile memory elements (e.g., RAM) and nonvolatile memory elements (e.g., read only memory (ROM), Flash memory, hard disk, etc.). Stored in memory 402 are various programs, for instance in software, including an operating system 406 and a write monitor 408. The operating system 406 controls the execution of other software and provides scheduling, input-output control, file and data management, memory management, and communication control and related services. The write monitor 408 monitors the progress of external storage devices that are connected to the computer 100 via one of the ports 110 or 114 to identify when writing has actually been completed within the devices. As is described below, the monitor 408 may accomplish this monitoring by issuing commands or queries to a given external storage device.

With further reference to FIG. 4, the connector hub 102 includes a device interface 410, such as a plug that is adapted for receipt by an I/O port 110 of the computer 100, and a controller 412 that is configured to route data between the devices that are plugged into the hub ports 114 and the computer 100. The controller 410 includes a processor 414 capable of executing instructions and memory 416 that comprises the instructions required to correctly route data (e.g., data packets) to and from the various devices. As shown in FIG. 4, each I/O port 114 of the hub, like those of the computer 100, includes its own indicator 300. Notably, however, the indicators 300 can be separate and independent of the ports 114.

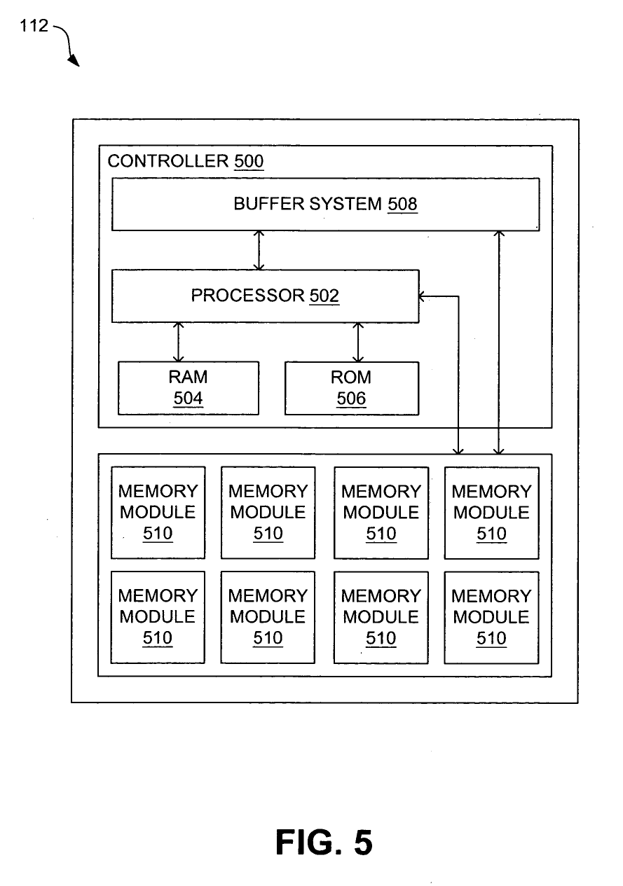

FIG. 5 provides an example configuration for the external storage device 112. As indicated in that figure, the external storage device 102 comprises a controller 500 and at least one memory module 510. The controller 500 can comprise a single, integrated component (e.g., an application specific integrated circuit (ASIC)) and/or a plurality of discrete components that together provide a control functionality. Typically, however, the controller 500 is formed as an integrated semiconductor device that is used to control and manage operation of the external storage device 112.

As indicated in FIG. 5, the controller 500 comprises a processor 502, RAM 504, ROM 506, and a buffer system 508. The processor 502 controls operation of the controller 500 in accordance with boot and operating code (e.g., firmware) stored within the ROM 506. In addition, the ROM 506 may comprise the logic used to respond to commands or queries pertaining to write completion status. The processor 502 is configured to receive storage commands from the host system (e.g., computer 100) via the buffer system 508, and control the delivery of blocks of data to designated storage device addresses of the various memory modules 510. The memory modules 510 comprise any nonvolatile, solid-state memory with which large amounts of data may be stored. Examples include flash memory, atomic resolution storage memory, and magnetic random access memory (MRAM).

When data is to be written to the external storage device 112, write commands are received by the processor 502 that specify addresses to be associated with the data, and the data is cached in the buffer system 508. The addresses are mapped by the processor 502 to an appropriate storage device address. The RAM 504 can be used by the processor 502 as a computing resource during this mapping. The processor 502 then causes the buffer system 508 to provide its cached data (e.g., in independent blocks) to the memory modules 510 so that the data is written to the mapped storage device addresses.

Various programs (logic) have been described above. These programs can be stored on any computer-readable medium for use by or in connection with any computer-related system or method. In the context of this disclosure, a computer-readable medium is an electronic, magnetic, optical, or other physical device or means that contains or stores a computer program for use by or in connection with a computer-related system or method. Programs can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

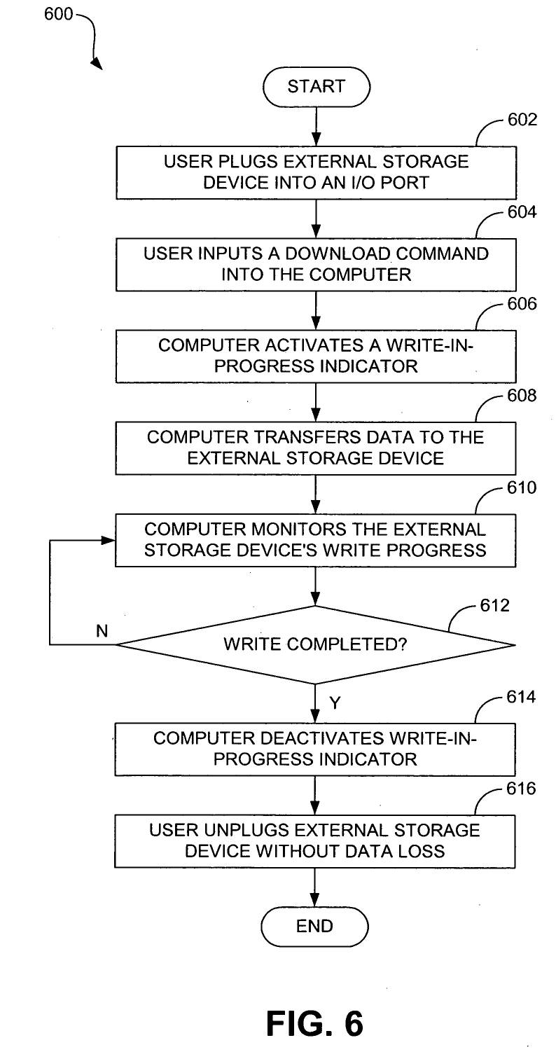

FIG. 6 is a flow diagram 600 that provides an overview of a method for signaling completion of writing in an external storage device. Process steps or blocks in the flow diagrams of this disclosure may represent modules, segments, or portions of code that include one or more executable instructions for implementing specific logical functions or steps in the process. Although particular example process steps are described, alternative implementations are feasible. Moreover, steps may be executed out of order from that shown or discussed, including substantially concurrently or in reverse order, depending on the functionality involved.

Beginning with block 602 of FIG. 6, a user plugs an external storage device into an I/O port. The I/O port may comprise a port of a computer (e.g., a port 110 of computer 100, FIG. 1) or a port of another device that is plugged into a computer (e.g., a port 114 of hub 102, FIG. 1). Assuming that the user desires to write data from the computer to the external storage device, the user then inputs a download command into the computer, as indicated in block 604. That command may be input into the computer operating system, or into a user application that executes on top of the operating system.

Once the download command is received, the computer activates a write-in-progress indication, as indicated in block 606, which indicates to the user that writing to the storage media of the external storage device is has not yet completed, and therefore warns the user against unplugging the external storage device from the computer. By way of example, activation of the indicator comprises illumination of a light associated with the I/O port to which the external storage device is connected (whether it be on the computer or on a connector hub).

Next, as indicated in block 608, the computer transfers data to the external storage device and, as indicated in block 610, monitors the external storage device's write progress. Specifically, the computer determines whether the external storage device has completed writing data to its non-volatile storage media that the device received in its buffer. With reference to decision block 612, if the write is not completed, monitoring continues at block 610. However, if the computer determines that the write has been completed, the computer deactivates the write-in-progress indicator, as indicated in block 614 to signal to the user that it is now safe to unplug the external storage device from the I/O port without losing data due to power loss that interrupts writing. Therefore, with reference to block 616, the user unplugs the external storage device without data loss.

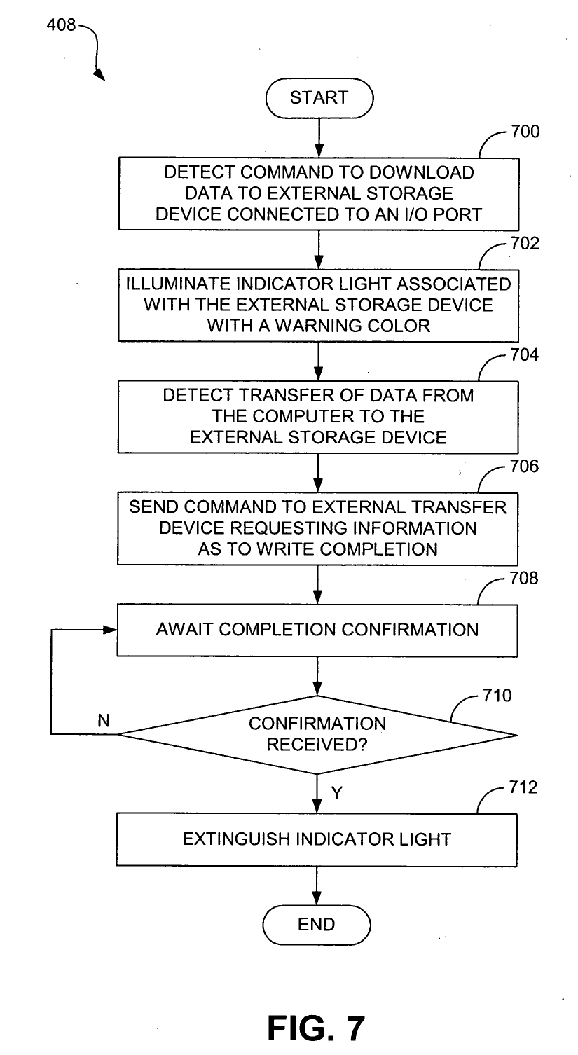

FIG. 7 provides an example of operation of the write monitor 408 of the computer 100 in signaling a user as to when a write has been completed. Beginning with block 700, the write monitor 408 first detects a command, received by the computer 100, to download data to an external storage device that is connected to an I/O port, whether it be a port of the computer or a port of another device (e.g., connector hub) that is plugged into the computer. Once such a command has been received, the write monitor 408 illuminates an indicator light associated with the external storage device at issue with a warning color, as indicated in block 702. Notably, illumination of the indicator light may coincide with initiation of the transfer of data to the external storage device or may precede such transfer (transfer may be delayed by execution by the computer of other instruction streams).

In the case of an indicator light of the computer (e.g., indicator 110 in FIG. 1), illumination may be accomplished by issuing an advanced configuration power interface (ACPI) command that activates a switch, such as a general purpose out (GPO), associated with the indicator. In the case of an indicator light of another device, such as a connector hub, illumination may be accomplished by transmitting a command to the other device that instructs that device to illuminate the appropriate indicator light (e.g., indicator 114 in FIG. 1). In either situation, the warning color may be selected to suit the desired implementation. By way of example, the warning color may be red, which conveys the danger in prematurely removing a plug (i.e., danger of potential data loss). Other colors (including clear) could be used, however.

Referring next to block 704, the write monitor 408 detects transfer of data from the computer to the external storage device. This detection may comprise detection of data transfer initiation or detection of data transfer completion depending upon the particular implementation. At either point, the write monitor 408 sends a command to the external storage device via the I/O port (and cable where applicable) requesting information as to write completion, as indicated in block 706. Although a “command” has been specified, other equivalent alternatives exist. For example, a series of queries could be transmitted to the external storage device to which “yes” or “no” replies as to write completion are received. For the purposes of this discussion, however, it is assumed that the write monitor 408 sends only a single command and then, as indicated in block 708, awaits a completion confirmation.

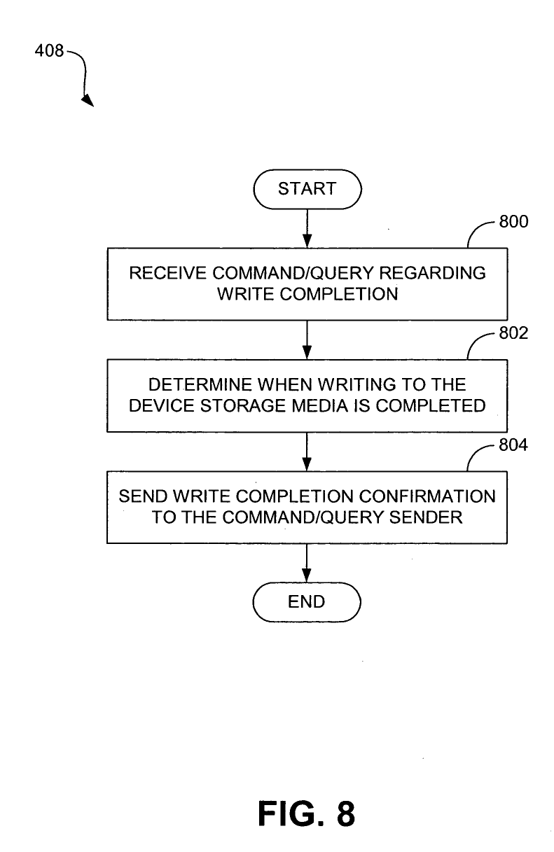

Reference is now made to the flow diagram 800 of FIG. 8, which illustrates an example of operation of an external storage device, such as device 112 shown in FIGS. 1 and 5, in responding to a computer with write status information. Beginning with block 802, the external storage device receives a command or query regarding write completion. In response to the command/query, the external storage device determines when writing to the device's storage media (as contrasted with caching data in a buffer) is completed, as indicated in block 804. Assuming such writing to be completed (e.g., a few seconds after all data has been transferred to the external storage device), the external storage device then sends a write completion confirmation to the command/query sender (e.g., computer operating system).

Returning to FIG. 7, the write monitor 408 determines whether a write confirmation has been received, as indicated in decision block 710. If not, the write monitor 408 continues to wait for such confirmation. Notably, this waiting can time-out if no confirmation is received after a predetermined period of time (e.g., due to an error). Once confirmation has been received, however, the write monitor 408 extinguishes the indicator light, as indicated in block 712, thereby signaling the user that the external storage device is done writing data to its storage media and that the device may now be unplugged safely.

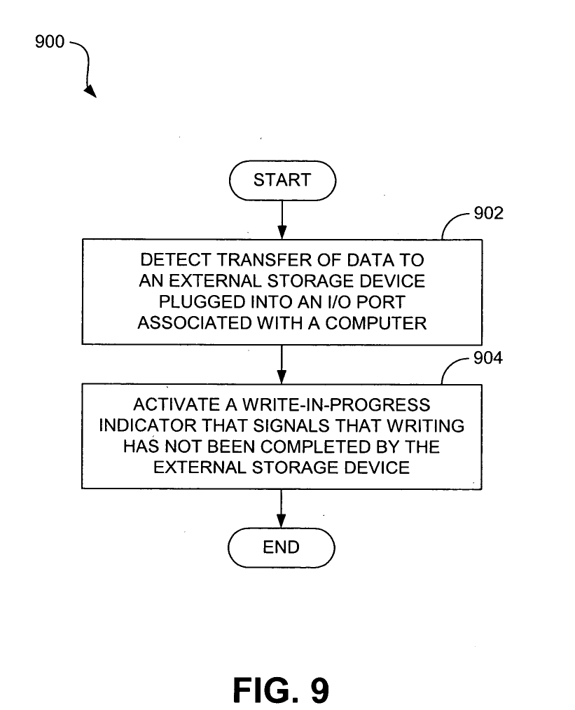

A further method 900 for signaling write completion is described with reference to FIG. 9. As indicated in that figure, the method 900 comprises detecting transfer of data from a computer to an external storage device plugged into an input/output port associated with the computer (block 902), activating an write-in-progress indicator that signals that writing has not be completed by the external storage device (block 904), determining when the external storage device has completed writing data to its storage media (block 906), and deactivating the write-in-progress indicator when it is determined that writing has been completed (block 908).

1. A method for signaling write status, the method comprising:
detecting transfer of data to an external storage device plugged into an input/output port associated with a computer; and
activating a write-in-progress indicator that signals that writing has not been completed by the external storage device.

2. The method of claim 1, wherein detecting transfer of data comprises detecting transfer of data to an external storage device plugged into an input/output port of the computer.

3. The method of claim 2, wherein detecting transfer of data comprises detecting transfer of data to an external storage device plugged into an input/output port provided in a front panel of the computer.

4. The method of claim 2, wherein activating a write-in-progress indicator comprises activating an indicator of the computer that is adjacent the input/output port.

5. The method of claim 1, wherein detecting transfer of data comprises detecting transfer of data to an external storage device plugged into an input/output port of a connector hub that is connected to the computer.

6. The method of claim 5, wherein activating a write-in-progress indicator comprises activating an indicator of the connector hub that is adjacent the input/output port.

7. The method of claim 1, wherein activating a write-in-progress indicator comprises activating an indicator light associated with the input/output port.

8. The method of claim 7, wherein activating an indicator light comprises activating a light-emitting diode associated with the input/output port.

9. The method of claim 1, wherein activating a write-in-progress indicator comprises issuing an advanced configuration power interface command to a switch that controls the indicator.

10. The method of claim 1, further comprising determining when the external storage device has completed writing and deactivating the write-in-progress indicator when it is determined that writing has been completed.

11. The method of claim 10, wherein determining when the external storage device has completed writing comprises communicating with the external storage device to obtain information regarding a write status of the external storage device.

12. The method of claim 11, wherein communicating with the external storage device comprises sending a command requesting confirmation when writing is completed or a query requesting an indication as to whether writing is completed.

13. A system for signaling write status, the system comprising:
means for detecting transfer of data to an external storage device plugged into an input/output port associated with a computer;
means for activating a write-in-progress indicator that signals that writing has not been completed by the external storage device;
means for determining when the external storage device has completed writing; and
means for deactivating the write-in-progress indicator when it is determined that writing has been completed.

14. The system of claim 13, wherein the means for detecting transfer of data comprise means for detecting transfer of data to an external storage device plugged into an input/output port of the computer.

15. The system of claim 13, wherein the means for detecting transfer of data comprise means for detecting transfer of data to an external storage device plugged into an input/output port of a connector hub connected to the computer.

16. The system of claim 13, wherein the means for activating a write-in-progress indicator comprise means for activating an indicator light that is adjacent the input/output port.

17. The system of claim 13, further comprising an indicator light adapted for placement next to the input/output port.

18. A system stored on a computer-readable medium, the system comprising:
logic configured to activate a write-in-progress indicator when data is transferred to an external storage device that is plugged into an input/output port associated with a computer, the indicator signaling that writing has not been completed by the external storage device;
logic configured to determine when the external storage device has completed writing; and
logic configured to deactivate the write-in-progress indicator when it is determined that writing has been completed.

19. The system of claim 18, wherein the logic configured to activate a write-in-progress indicator comprises logic configured to activate an indicator adjacent the input/output port.

20. The system of claim 19, wherein the logic configured to activate a write-in-progress indicator comprises logic configured to issue an advanced configuration power interface command to a switch that controls the indicator.

21. The system of claim 18, wherein the logic configured to determine when the external storage device has completed writing comprises logic configured to send a command or query to the external storage device requesting information regarding a write status of the external storage device.

22. The system of claim 21, wherein the logic configured to send a command or query is configured to request a confirmation notification that writing has been completed.

23. A computer, comprising:
a processor; and
memory that contains a write monitor configured to activate a write-in-progress indicator when data is transferred to an external storage device that is plugged into an input/output port associated with the computer, determine when the external storage device has completed writing, and deactivate the write-in-progress indicator when it is determined that writing has been completed.

24. The computer of claim 23, further comprising an input/output port provided on a front panel of the computer.

25. The computer of claim 24, wherein the input/output port is a universal serial bus port.

26. The computer of claim. 24, further comprising an indicator light provided on the front panel adjacent the input/output port.

27. The computer of claim 26, wherein the indicator light is a light-emitting diode.

28. A connector hub, comprising:
a controller;
an input/output port adapted to receive a plug of an external storage device; and
an indicator light positioned adjacent the input/output port;
wherein the connector hub is configured such that the indicator light illuminates a warning signal while writing is in progress in the external storage device.

29. The connector hub of claim 28, wherein the input/output port is a universal serial bus port.

30. The connector hub of claim 28, wherein the indicator light is a light-emitting diode.

31. An external storage device, comprising:
a processor;
a buffer system that is configured to receive data transferred from a computer;
storage media that is configured to store the data received by the buffer system; and
memory including logic configured to detect when all data cached in the buffer system has been written to the storage media and to further communicate a write completion status to the computer.

32. The external storage device of claim 31, wherein the storage media comprises one or more of flash memory, atomic resolution storage memory, and magnetic random access memory.
